(19) United States
(12) Patent Application Publication
(10) Pub. No.: US 2005/0128044 A1
(43) Pub. Date: Jun. 16, 2005

(54) Alloy type thermal fuse and wire member for a thermal fuse element

(75) Inventors: Miki Iwamoto, Osaka (JP); Naotaka Ikawa, Osaka (JP); Toshiaki Saruwatari, Osaka (JP); Yoshiaki Tanaka, Osaka (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Uchihashi Estec Co., Ltd.

(21) Appl. No.: 10/954,765

(22) Filed: Sep. 30, 2004

(30) Foreign Application Priority Data
Dec. 15, 2003 (JP) P2003-416895

(51) Int. Cl. H01H 85/06; H01H 85/04

(52) U.S. Cl. 337/159; 420/557

(57) ABSTRACT

An alloy type thermal fuse is provided in which, although a fuse element essentially comprising an In—Sn alloy is used, shear breakage at the melting point or lower can be prevented from occurring even under long-term DC application, the operation stability to a heat cycle can be satisfactorily assured, and a process of drawing to the fuse element at a high yield can be ensured, and which has an operating temperature belonging to the range of 120 to 150° C. As a metal element for preventing long-term DC breakage which prevents the fuse element from being broken under long-term DC application, Cu is added to an In—Sn composition of 52 to 85% In and a balance Sn.

### BACKGROUND OF THE INVENTION

1. Field of the Invention

The present invention relates to an alloy type thermal fuse in which the operating temperature belongs to the range of about 120 to 150° C., and a wire member for such a thermal fuse element.

An alloy type thermal fuse is widely used as a thermoprotector for an electrical appliance or a circuit element, for example, a semiconductor device, a capacitor, or a resistor.

Such an alloy type thermal fuse has a configuration in which an alloy of a predetermined melting point is used as a fuse element, a flux is applied to the fuse element, and the flux-applied fuse element is sealed by an insulator.

The alloy type thermal fuse has the following operation mechanism.

The alloy type thermal fuse is disposed so as to thermally contact an electrical appliance or a circuit element which is to be protected. When the electrical appliance or the circuit element is caused to generate heat by any abnormality, the fuse element alloy of the thermal fuse is melted by the generated heat, and the molten alloy is divided and spheroidized because of the wettability with respect to a lead conductor or an electrode under the coexistence with the flux that has already melted. The power supply is finally interrupted as a result of advancement of the division and spheroidization. The temperature of the appliance is lowered by the power supply interruption, and the divided molten alloys are solidified, whereby the non-return cut-off operation is completed. Therefore, it is requested that the division temperature of the fuse element alloy is substantially equal to the allowable temperature of an electrical appliance or the like.

Usually, a low-melting alloy is used as such a fuse element. As apparent from a phase equilibrium diagram, an alloy has a solidus temperature and a liquidus temperature, and, at the eutectic point where the solidus temperature coincides with the liquidus temperature, the alloy is changed all at once from the solid phase to the liquid phase by heating which causes the alloy to pass the eutectic temperature. By contrast, in a composition other than the eutectic point, an alloy is changed in the sequence of the solid phase→the solid-liquid coexisting phase→the liquid phase, and the solid-liquid coexisting region temperature width ΔT exists between the solidus temperature Ts and the liquidus temperature Tl. Even in the solid-liquid coexisting region, there is the possibility that the division of a fuse element occurs, although the possibility is low. In order to reduce the dispersion of the operating temperature among thermal fuses, it is requested to use an alloy composition in which the solid-liquid coexisting region temperature width ΔT is as narrow as possible. One of conditions imposed on an alloy type thermal fuse is that ΔT is narrow.

In many cases, a fuse element of an alloy type thermal fuse is used in the form of a linear piece. In order to reduce the size of a thermal fuse so as to comply with the recent tendency that appliances are further miniaturized, it is sometimes demanded to realize a thin fuse element. A fuse element is often requested to have drawability to a small diameter (for example, 400 μmφ or smaller).

In recent electrical appliances, the use of materials harmful to a living body, particularly metals such as Pb, Cd, Hg, and Tl is restricted because of increased awareness of environment conservation. Also a fuse element for a thermal fuse is requested not to contain such a harmful metal.

2. Description of the Prior Art

When alloy type thermal fuses are classified according to operating temperature, thermal fuses of an operating temperature of 120 to 150° C. are widely used.

As apparent from a phase equilibrium diagram of an In—Sn alloy, in an alloy of 85 to 52% In and a balance Sn, the liquidus temperature is 119 to 145° C. In this range, as compared with the range of an alloy composition of 52 to 43% In and a balance Sn where the liquidus temperature is similarly 119 to 145° C., the solidus temperature is higher, and hence the solid-liquid coexisting region temperature width is narrow. Therefore, the alloy of 85 to 52% In and a balance Sn satisfies the above-mentioned requirements such as the reduced dispersion of the operating temperature, the operating temperature in the range of 120 to 150° C. (in a thermal fuse, usually, the fuse element temperature is assumed to be lower by several degrees centigrade than the surface temperature, and the operating temperature to be higher by several degrees centigrade than the melting point of the fuse element), and environment conservation of harmful metal free.

Usually, In has high ductility, and an alloy containing a large amount of In has excessive ductility, so that such an alloy is hardly drawn.

However, an alloy type thermal fuse of an operating temperature of 120 to 130° C. has been proposed in which, assuming that an In—Sn alloy containing In of 70% or less can be drawn, an alloy of 70 to 52% In and a balance Sn (the lower limit of In is set to 52% in order to suppress dispersion of the operating temperature as descried above) is used as a fuse element (for example, Patent Reference 1).

[Patent Reference 1] Japanese Patent Application Laying-Open No. 2002-25402

Because of load variations of an appliance, temperature variations, or the like, a thermal fuse is subjected to a heat cycle, and thermal stress is applied to a fuse element. In a usual alloy type thermal fuse, however, the characteristics of a fuse element is not changed by such thermal stress.

However, the inventors have noted that, when the above-mentioned In—Sn alloy containing In of 52% or more is used as a fuse element, a resistance variation of a fuse element (rise of the resistance) is remarkably caused by a heat cycle. This phenomenon is produced by the fact that a slip in the interface between different phases in the alloy structure is increased, and such a slip repeatedly occurs, whereby a change of a sectional area or an elongation of the fuse element is caused in an excessive manner.

When such an increase of the resistance occurs, the temperature of the fuse element is raised by Joule's heat. When the temperature rise is indicated by ΔT, the fuse operates at a temperature that is lower than the allowable temperature of an appliance by the temperature rise ΔT, and, when the temperature rise ΔT is large, a serious operation error may occur.

As a result of intensive study, therefore, the inventors have already proposed a technique that “an alloy composition in which 0.1 to 7 weight parts of one, or two or more metals selected from the group consisting of Ag, Au, Cu, Ni, Pd, Pt, and Sb are added to 100 weight parts of an alloy of 52 to 85% In and a balance Sn is used as a fuse element of a thermal fuse” (Japanese Patent Application No. 2002-207236).

### SUMMARY OF THE INVENTION

Even after the proposal, the inventors have continuously intensively studied for the use of an alloy essentially comprising the above-mentioned In—Sn composition as a thermal fuse element. However, the inventors have unexpectedly found that, when a DC current is applied for a long term, a fuse element is broken by shear at a temperature which is lower than the melting point of the fuse element. It has been ascertained that this phenomenon does not occur when an AC current is applied and is inherent in an application of a DC current.

An example of this long-term DC application breakage will be described. A wire member of a diameter of 500 μmφ was obtained by drawing an In—Sn alloy of 74% In and 26% Sn. Cylindrical thermal fuses (50 fuses) in which the wire member is used as a fuse element were placed in a thermostatic bath of 94° C. A DC current of 5 A was applied to the fuses for 3,000 hours. As a result, although the fuse element temperature was not higher than the melting point, about 50% of the samples were obliquely broken by shear at a middle of each fuse element.

By contrast, when an AC current (having a peak value of √2×5 A) in which the RMS value is equal to the value of the DC current was applied for 3,000 hours, no abnormality was observed.

As a phenomenon in which a fuse element is broken at a temperature not higher than the melting point, known is a phenomenon in which crystal transformation occurs at a specific temperature lower than the melting point and a fuse element is broken by a stress produced by a volume change due to the crystal transformation. However, it has been ascertained by a DSC (Differential Scanning Calorimeter) that the long-term DC application breakage is not based on the crystal transformation.

Although remaining a matter of speculation, the cause of the long-term DC application breakage of a fuse element is speculated that the DC application causes the whole length of the fuse element to be subjected to a central compressive force by the function of an electromagnetic force, an axial compressive force due to the Poisson's ratio hence acts on the fuse element, and the fuse element of an In—Sn alloy which is soft because of the large amount of In is broken by shear in an inclined plane where a shear stress due to the axial compressive force acts.

As a reason that the shear breakage is caused in DC application but not in AC application, the following breakage mechanism can be assumed. In AC application, when the angular frequency is indicated by ω, the shear stress in the inclined plane is an alternating force having a frequency of 2ω (F=sin 2 ωt). During a period when the alternating stress becomes zero, distortions between crystals are restored. By contrast, in DC application, the frequency is 0, and therefore distortions between crystals are accumulated. Finally, the fuse element is broken by shear.

The fact that the long-term DC application breakage in a fuse element of an In—Sn composition is shear breakage in a direction oblique to the fuse element conforms to the assumption.

Because of the above-discussed reason, in order to use an In—Sn composition as a principal component of a fuse element of an alloy type thermal fuse, it is necessary to prevent the fuse element from being broken by shear under long-term DC application.

It is an object of the invention to provide an alloy type thermal fuse in which, although a fuse element essentially comprising an In—Sn alloy is used, shear breakage at the melting point or lower can be prevented from occurring even under long-term DC application, the operation stability to a heat cycle can be satisfactorily assured, and a process of drawing to the fuse element at a high yield can be ensured, and which has an operating temperature belonging to the range of 120 to 150° C.

The wire member for a thermal fuse element of a first aspect of the invention is a wire member for a fuse element of an alloy type thermal fuse, and characterized in that a metal element for preventing long-term DC breakage is added to an In—Sn composition of 52 to 85% In and a balance Sn, the metal element preventing the fuse element from being broken under long-term DC application.

The wire member for a thermal fuse element of a second aspect of the invention is characterized in that, in the wire member for a thermal fuse element of the first aspect of the invention, the metal element for preventing long-term DC breakage is Cu, and an addition amount of the metal is 0.1 to 7 weight parts with respect to 100 weight parts of the In—Sn composition.

The alloy type thermal fuse of a third aspect of the invention is characterized in that the wire member for a thermal fuse element of the first or second aspect of the invention is used as a fuse element.

The alloy type thermal fuse of a fourth aspect of the invention is characterized in that, in the alloy type thermal fuse of the third aspect of the invention, a heating element for fusing off the fuse element is additionally disposed.

In these aspects of the invention, the alloy composition is allowed to contain inevitable impurities which are produced in productions of metals of raw materials and also in melting and stirring of the raw materials.

In the case where an In—Sn composition of 52 to 85% In and a balance Sn is used as a fuse element of an alloy type thermal fuse, under long-term application of a DC current, shear breakage occurs at a temperature equal to or lower than the melting point, it is recognized that, when an alloy of the In—Sn composition is formed as an interstitial solid solution, shear breakage can be prevented from occurring, and an In—Sn alloy is formed into an interstitial solid solution structure by addition of Cu. Therefore, it is possible to eliminate the disadvantage of the shear breakage of a fuse element in long-term DC aging, and the thermal fuse can be safely used not only as a fuse for AC but also as that for DC.

The strength of the alloy is improved by the formation to an interstitial solid solution. Therefore, the thermal fatigue performance to a heat cycle can be improved, and a process of drawing to a thin wire of a diameter of 300 μmφ is enabled, so that the thermal fuse can be miniaturized.

Since the addition amount of Cu is 7 weight parts or smaller, the melting characteristic of the In—Sn composition in which the liquidus temperature is 120 to 150° C. and the solid-liquid coexisting region temperature width is narrow (6° C. or narrower) can be sufficiently maintained.

Therefore, it is possible to provide an alloy type thermal fuse in which the operating temperature belongs to 120 to 150° C., and dispersion of the operating temperature is sufficiently small, and which is suitable for environment conservation.

In the invention, the fuse element basically comprises an alloy composition of 52 to 85% In and the balance Sn because of the following reason. Since the liquidus temperature is 119 to 145° C. and the solid-liquid coexisting region temperature width is narrow or about 6° C. or narrower, the operating temperature of the thermal fuse can be set to 120 to 150° C., and dispersion of the operating temperature can be set to be small (4 to 5° C. or smaller).

The reason why the Cu element is effective for preventing long-term DC application breakage from occurring in a fuse element is assumed that Cu atoms enter the crystal lattice of the base material of the In—Sn alloy to form an interstitial solid solution, and the strength against the oblique shear breakage is improved.

This addition of Cu can improve the thermal fatigue performance to a heat cycle, and enables a process of drawing to a thin wire of diameter of 300 μmφ, so that the thermal fuse can be miniaturized.

The addition amount of Cu is set to 0.1 to 7 weight parts because of the following reason. When the amount is smaller than 0.1 weight parts, the formation into an interstitial solid solution is insufficiently conducted, and, when the amount exceeds 7 weight parts, the melting characteristic of the alloy of 52 to 85% In and a balance Sn cannot be sufficiently maintained.

In the invention, the fuse element can be produced by drawing a base material of an alloy, and used with remaining to have a circular section shape or with being further subjected to a compression process to be flattened. In the case of a round wire, the outer diameter of the fuse element is 200 to 600 μmφ, preferably, 250 to 350 μmφ.

The invention may be implemented in the form of a thermal fuse serving as an independent thermoprotector. Alternatively, the invention may be implemented in the form in which a thermal fuse element is connected in series to a semiconductor device, a capacitor, or a resistor, a flux is applied to the element, the flux-applied fuse element is placed in the vicinity of the semiconductor device, the capacitor, or the resistor, and the fuse element is sealed together with the semiconductor device, the capacitor, or the resistor by means of resin mold, a case, or the like.

### BRIEF DESCRIPTION OF THE DRAWINGS

FIG. 1 is a view showing an example of the alloy type thermal fuse of the invention;

FIG. 2 is a view showing another example of the alloy type thermal fuse of the invention;

FIG. 3 is a view showing a further example of the alloy type thermal fuse of the invention;

FIG. 4 is a view showing a still further example of the alloy type thermal fuse of the invention; and

FIG. 5 is a view showing a still further example of the alloy type thermal fuse of the invention.

### DETAILED DESCRIPTION OF THE PREFERRED EMBODIMENTS

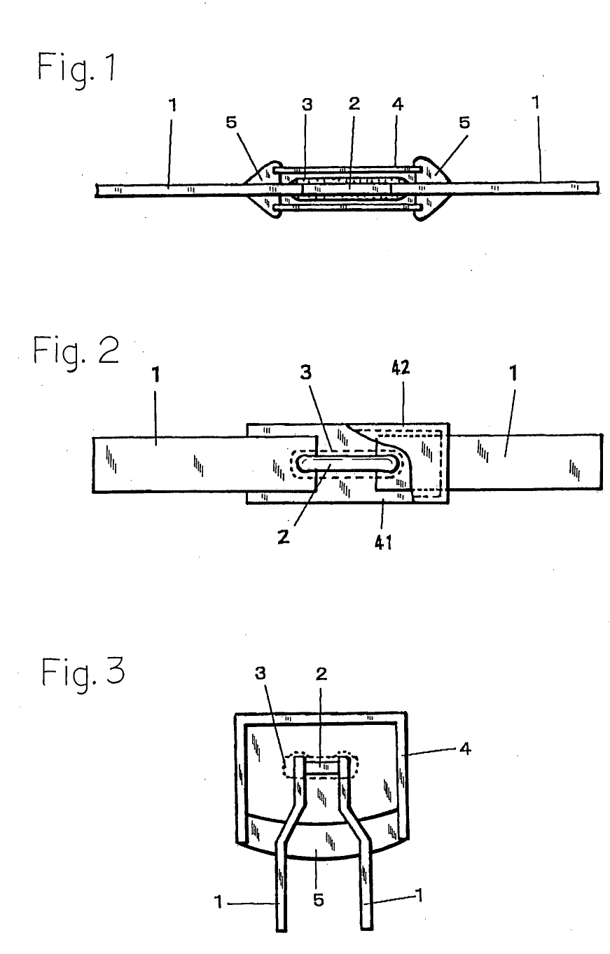

FIG. 1 shows an alloy type thermal fuse of the cylindrical case type according to the invention. A low-melting fusible alloy piece 2 is connected between a pair of lead wires 1, 1. A flux 3 is applied to the low-melting fusible alloy piece 2. The flux-applied low-melting fusible alloy piece is passed through an insulating tube 4 which is excellent in heat resistance and thermal conductivity, for example, a ceramic tube. Gaps between the ends of the insulating tube 4 and the lead wires 1 are sealingly closed by a cold-setting sealing agent 5 such as an epoxy resin.

FIG. 2 shows a tape-like alloy type thermal fuse according to the invention. In the fuse, strip lead conductors 1, 1 having a thickness of 100 to 200 μm are fixed by an adhesive agent or fusion bonding to a plastic base film 41 having a thickness of 100 to 300 μm. A fuse element 2 having a diameter of 250 to 500 μmφ is connected between the strip lead conductors. A flux 3 is applied to the fuse element 2. The flux-applied fuse element is sealed by means of fixation of a plastic cover film 42 having a thickness of 100 to 300 μm by an adhesive agent or fusion bonding.

FIG. 3 shows a fuse of the radial case type. A fuse element 2 is bonded between tip ends of parallel lead conductors 1, 1 by welding. A flux 3 is applied to the fuse element 2. The flux-applied fuse element is enclosed by an insulating case 4 in which one end is opened, for example, a ceramic case. The opening of the insulating case 4 is sealingly closed by a sealing agent 5 such as an epoxy resin.

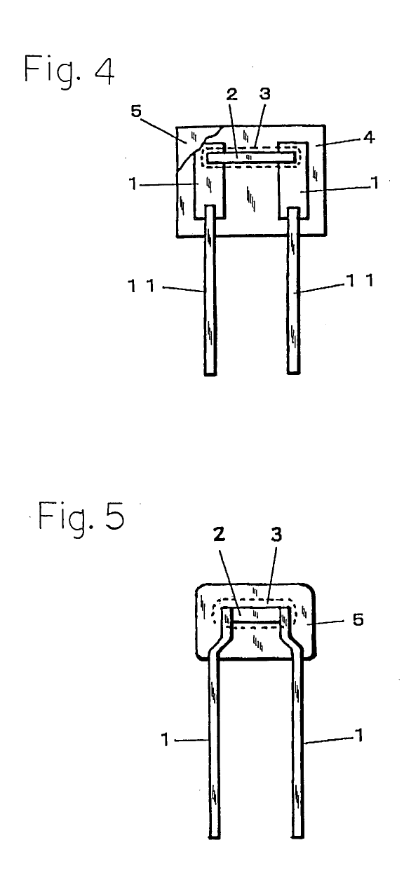

FIG. 4 shows a fuse of the substrate type. A pair of film electrodes 1, 1 are formed on an insulating substrate 4 such as a ceramic substrate by printing of conductive paste (for example, silver paste). Lead conductors 11 are connected respectively to the electrodes 1 by welding or the like. A fuse element 2 is bonded between the electrodes 1, 1 by welding. A flux 3 is applied to the fuse element 2. The flux-applied fuse element is covered by a sealing agent 5 such as an epoxy resin.

FIG. 5 shows a fuse of the radial resin dipping type. A fuse element 2 is bonded between tip ends of parallel lead conductors 1, 1 by welding. A flux 3 is applied to the fuse element 2. The flux-applied fuse element is dipped into a resin solution to seal the element by an insulative sealing agent such as an epoxy resin 5.

The invention may be implemented in the form in which a heating element is additionally disposed on the alloy type thermal fuse, for example, a film resistor is additionally disposed by applying and baking resistance paste (e.g., paste of metal oxide powder such as ruthenium oxide), a precursor causing abnormal heat generation of an appliance is detected, the film resistor is energized to generate heat in response to a signal indicative of the detection, and the fuse element is fused off by the heat generation.

In this case, the heating element is disposed on the upper face of an insulating substrate, and a heat-resistant and thermal-conductive insulating film such as a glass baked film is formed on the heating element. A pair of electrodes are disposed, flat lead conductors are connected respectively to the electrodes, and the fuse element is connected between the electrodes. A flux covers a range over the fuse element and the tip ends of the lead conductors. An insulating cover is placed on the insulating substrate, and the periphery of the insulating cover is sealingly bonded to the insulating substrate by an adhesive agent.

As the flux, a flux having a melting point which is lower than that of the fuse element is generally used. For example, useful is a flux containing 90 to 60 weight parts of rosin, 10 to 40 weight parts of stearic acid, and 0 to 3 weight parts of an activating agent. In this case, as the rosin, a natural rosin, a modified rosin (for example, a hydrogenated rosin, an inhomogeneous rosin, or a polymerized rosin), or a purified rosin thereof can be used. As the activating agent, hydrochloride of diethylamine, hydrobromide of diethylamine, or an organic acid such as adipic acid can be used.

In the following examples and comparative examples, thermal fuses of the cylindrical case type produced in the following manner were used as alloy type thermal fuses. Lead conductors are connected to both ends of a fuse element having a diameter of 600 μmφ and a length of 3.5 mm, respectively. A flux in which rosin is used as a principal component and 1 w. % of adipic acid is added is applied to the fuse element. The flux-applied fuse element is passed through a ceramic tube having an outer diameter of 2.5 mmφ, a thickness of 0.5 mm, and a length of 9 mm. Gaps between the ends of the ceramic tube and the lead wires are sealingly closed by a cold-setting sealing agent such as an epoxy resin.

With respect to the operating temperatures of the examples and comparative examples, fifty specimens were used, the specimens were immersed into an oil bath in which the temperature was raised at a rate of 1° C./min., while supplying a current of 0.1 A to the specimens, and the temperature of the oil when the current supply was interrupted by blowing-out was measured.

The long-term DC application agings in the examples and comparative examples were evaluated in the following manner. Fifty specimens were used. The specimens were placed in a thermostatic bath of an operating temperature of −35° C. A DC current of 5 A was applied for 3,000 hours. After the application, the presence or absence of breakage of the fuse element was checked by a soft X-ray observation apparatus. The case where breakage does not occur in all of the specimens was judged acceptable.

The operating temperature after the long-term DC application aging test was measured in the following manner. The specimens were immersed into an oil bath in which the temperature was raised at a rate of 1° C./min., while supplying a current of 0.1 A to the specimens. The temperature of the oil when the current supply was interrupted by blowing-out was measured.

In order to ascertain that breakage due to long-term application is inherent in DC, in the comparative examples, fifty specimens were used, the specimens were placed in a thermostatic bath of an operating temperature of −35° C., an AC current (a peak value of √2×5 A) in which the RMS value is equal to DC 5 A was applied for 3,000 hours, and, after the application, the presence or absence of breakage of the fuse element was checked by a soft X-ray observation apparatus. It was ascertained that breakage does not occur in all of the specimens.

With respect to the change in resistance of a fuse element caused by a heat cycle, 50 specimens were used, and judgment was made by measuring a resistance change after a heat cycle test of 500 heat cycles in each of which specimens were heated to 110° C. for 30 minutes and cooled to −40° C. for 30 minutes. When, in all the specimens, the resistance increase was 50% or less, it was judged acceptable, and, when, in even one of the specimens, the resistance increase was larger than 50%, it was judged unacceptable.

With respect to the drawability of a fuse element, the draw-down ratio per dice was 6.5%, and the drawing speed was 45 m/min. When the specimens were drawn into a wire of 300 μm in diameter without breakage, it was judged ◯, and, when drawn with breakage, it was judged x.

### EXAMPLE 1

Cylindrical thermal fuses were produced while setting the alloy composition of a fuse element to 74 parts of In (weight parts, this is applicable hereinafter), 26 parts of Sn, and 0.7 parts of Cu.

The operating temperature was 130.0±1° C.

In the long-term DC application aging test, no fuse element was broken. Therefore, the long-term DC application aging was evaluated as acceptable.

The operating temperatures of fifty specimens after the long-term DC application aging test were measured. As a result, the operating temperatures were in the range of 129.4 to 131.0° C., and no substantial change with respect to those before the aging test was observed. The operation performance was able to be stably maintained.

There was no specimen in which the resistance was increased by 1.5 times or larger as a result of the heat cycle test. Therefore, the resistance to a heat cycle test was evaluated as acceptable.

No specimen was broken in the process of drawing to a wire of 300 μmΦ. Therefore, the drawability was evaluated as ◯.

### EXAMPLE 2

Cylindrical thermal fuses were produced while setting the alloy composition of a fuse element to 74 parts of In (weight parts, this is applicable hereinafter), 26 parts of Sn, and 0.4 parts of Cu.

The operating temperature was 129.5±1° C.

In the long-term DC application aging test, no fuse element was broken. Therefore, the long-term DC application aging was evaluated as acceptable.

The operating temperatures of fifty specimens after the long-term DC application aging test were measured. As a result, the operating temperatures were in the range of 128.9 to 130.8° C., and no substantial change with respect to those before the aging test was observed.

There was no specimen in which the resistance was increased by 1.5 times or larger as a result of the heat cycle test. Therefore, the resistance to a heat cycle test was evaluated as acceptable.

No specimen was broken in the process of drawing to a wire of 300 μmφ. Therefore, the drawability was evaluated as ◯.

### EXAMPLE 3

Cylindrical thermal fuses were produced while setting the alloy composition of a fuse element to 74 parts of In (weight parts, this is applicable hereinafter), 26 parts of Sn, and 4 parts of Cu.

The operating temperature was 131.0±2° C.

In the long-term DC application aging test, no fuse element was broken. Therefore, the long-term DC application aging was evaluated as acceptable.

The operating temperatures of fifty specimens after the long-term DC application aging test were measured. As a result, the operating temperatures were in the range of 129.8 to 132.2° C., and no substantial change with respect to those before the aging test was observed.

There was no specimen in which the resistance was increased by 1.5 times or larger as a result of the heat cycle test. Therefore, the resistance to a heat cycle test was evaluated as acceptable.

No specimen was broken in the process of drawing to a wire of 300 μmφ. Therefore, the drawability was evaluated as ◯.

### EXAMPLE 4

Cylindrical thermal fuses were produced while setting the alloy composition as listed in Table 1.

The operating temperatures were as listed in Table 1.

In the long-term DC application aging test, no fuse element was broken, and therefore all the specimens were evaluated as acceptable. The operating temperatures of the specimens of the example after the long-term DC application aging test were measured. As a result, no substantial change with respect to those before the aging test was observed.

There was no specimen in which the resistance was increased by 1.5 times or larger as a result of the heat cycle test. Therefore, the resistance to a heat cycle test was evaluated as acceptable.

No specimen was broken in the process of drawing the material of the alloy to a wire of 300 μmφ. Therefore, the drawability was evaluated as ◯.

### EXAMPLE 5

Cylindrical thermal fuses were produced while setting the alloy composition as listed in Table 1.

The operating temperatures were as listed in Table 1.

In the long-term DC application aging test, no fuse element was broken, and therefore all the specimens were evaluated as acceptable. The operating temperatures of the specimens of the example after the long-term DC application aging test were measured. As a result, no substantial change with respect to those before the aging test was observed.

There was no specimen in which the resistance was increased by 1.5 times or larger as a result of the heat cycle test. Therefore, the resistance to a heat cycle test was evaluated as acceptable.

No specimen was broken in the process of drawing the material of the alloy to a wire of 300 μm+. Therefore, the drawability was evaluated as ◯.

### EXAMPLE 6

Cylindrical thermal fuses were produced while setting the alloy composition as listed in Table 1.

The operating temperatures were as listed in Table 1.

In the long-term DC application aging test, no fuse element was broken, and therefore all the specimens were evaluated as acceptable. The operating temperatures of the specimens of the example after the long-term DC application aging test were measured. As a result, no substantial change with respect to those before the aging test was observed.

There was no specimen in which the resistance was increased by 1.5 times or larger as a result of the heat cycle test. Therefore, the resistance to a heat cycle test was evaluated as acceptable.

No specimen was broken in the process of drawing the material of the alloy to a wire of 300 μmφ. Therefore, the drawability was evaluated as ◯.

### EXAMPLE 7

Cylindrical thermal fuses were produced while setting the alloy composition as listed in Table 1.

The operating temperatures were as listed in Table 1.

In the long-term DC application aging test, no fuse element was broken, and therefore all the specimens were evaluated as acceptable. The operating temperatures of the specimens of the example after the long-term DC application aging test were measured. As a result, no substantial change with respect to those before the aging test was observed.

There was no specimen in which the resistance was increased by 1.5 times or larger as a result of the heat cycle test. Therefore, the resistance to a heat cycle test was evaluated as acceptable.

No specimen was broken in the process of drawing the material of the alloy to a wire of 300 μmφ. Therefore, the drawability was evaluated as ◯.

### EXAMPLE 8

Cylindrical thermal fuses were produced while setting the alloy composition as listed in Table 1.

The operating temperatures were as listed in Table 1.

In the long-term DC application aging test, no fuse element was broken, and therefore all the specimens were evaluated as acceptable. The operating temperatures of the specimens of the example after the long-term DC application aging test were measured. As a result, no substantial change with respect to those before the aging test was observed.

There was no specimen in which the resistance was increased by 1.5 times or larger as a result of the heat cycle test. Therefore, the resistance to a heat cycle test was evaluated as acceptable.

No specimen was broken in the process of drawing the material of the alloy to a wire of 300 μmφ. Therefore, the drawability was evaluated as ◯.

### EXAMPLE 9

Cylindrical thermal fuses were produced while setting the alloy composition as listed in Table 1.

The operating temperatures were as listed in Table 1.

In the long-term DC application aging test, no fuse element was broken, and therefore all the specimens were evaluated as acceptable. The operating temperatures of the specimens of the example after the long-term DC application aging test were measured. As a result, no substantial change with respect to those before the aging test was observed.

There was no specimen in which the resistance was increased by 1.5 times or larger as a result of the heat cycle test. Therefore, the resistance to a heat cycle test was evaluated as acceptable.

No specimen was broken in the process of drawing the material of the alloy to a wire of 300 μmφ. Therefore, the drawability was evaluated as ◯.

### EXAMPLE 10

Cylindrical thermal fuses were produced while setting the alloy composition as listed in Table 1.

The operating temperatures were as listed in Table 1.

In the long-term DC application aging test, no fuse element was broken, and therefore all the specimens were evaluated as acceptable. The operating temperatures of the specimens of the example after the long-term DC application aging test were measured. As a result, no substantial change with respect to those before the aging test was observed.

There was no specimen in which the resistance was increased by 1.5 times or larger as a result of the heat cycle test. Therefore, the resistance to a heat cycle test was evaluated as acceptable.

No specimen was broken in the process of drawing the material of the alloy to a wire of 300 μmφ. Therefore, the drawability was evaluated as ◯.

### EXAMPLE 11

Cylindrical thermal fuses were produced while setting the alloy composition as listed in Table 1.

The operating temperatures were as listed in Table 1.

In the long-term DC application aging test, no fuse element was broken, and therefore all the specimens were evaluated as acceptable. The operating temperatures of the specimens of the example after the long-term DC application aging test were measured. As a result, no substantial change with respect to those before the aging test was observed.

There was no specimen in which the resistance was increased by 1.5 times or larger as a result of the heat cycle test. Therefore, the resistance to a heat cycle test was evaluated as acceptable.

No specimen was broken in the process of drawing the material of the alloy to a wire of 300 μmφ. Therefore, the drawability was evaluated as ◯.

### COMPARATIVE EXAMPLE 1

Cylindrical thermal fuses were produced while setting the alloy composition of a fuse element to 74 parts of In and 26 parts of Sn.

The operating temperature was 129.2±1° C.

In the long-term DC application aging test, in twenty-eight specimens among fifty specimens, a fuse element was broken. Therefore, the long-term DC application aging was evaluated as unacceptable. In order to ascertain that the breakage in the long-term DC application aging is inherent in the application of a DC current, a test was conducted which is identical with the above-mentioned test except that an AC current of the same RMS value is applied in place of the DC current. As a result, no specimen was broken. Therefore, it was ascertained that the breakage is inherent in the DC application.

In a half or more of the specimens, the resistance was increased by 1.5 times or larger as a result of the heat cycle test. Therefore, the resistance to a heat cycle test was evaluated as unacceptable.

A process of drawing the alloy base material to a diameter of 300 μmφ was tried at the draw-down ratio per dice of 6.5% and the drawing speed of 45 m/min. However, the specimens were broken. In order to prevent breakage from occurring, the draw-down ratio per dice must be reduced to 4.0%, and the drawing speed to 20 m/min. Therefore, the drawability was evaluated as x.

### COMPARATIVE EXAMPLE 2

Cylindrical thermal fuses were produced while setting the alloy composition of a fuse element to 52 parts of In and 48 parts of Sn.

The operating temperature was 119.0±1° C.

In the long-term DC application aging test, in twenty-two specimens among fifty specimens, a fuse element was broken. Therefore, the long-term DC application aging was evaluated as unacceptable. In order to ascertain that the breakage in the long-term DC application aging is inherent in the application of a DC current, a test was conducted which is identical with the above-mentioned test except that an AC current of the same RMS value is applied in place of the DC current. As a result, no specimen was broken. Therefore, it was ascertained that the breakage is inherent in the DC application.

In a half or more of the specimens, the resistance was increased by 1.5 times or larger as a result of the heat cycle test. Therefore, the resistance to a heat cycle test was evaluated as unacceptable.

A process of drawing the alloy base material to a diameter of 300 μmφ was conducted without breakage. Therefore, the drawability was evaluated as ◯.

TABLE 1

| | Ex. 1 | Ex. 2 | Ex. 3 | Ex. 4 | Ex. 5 |
|---|---|---|---|---|---|
| In (w. %) | 74 | 74 | 74 | 52 | 52 |
| Sn (w. %) | 26 | 26 | 26 | 48 | 48 |
| Cu (w. %) | 0.7 | 0.4 | 4 | 0.4 | 4 |
| Operating | 130.0 ± 1 | 129.5 ± 1 | 131.0 ± 2 | 119.0 ± 1 | 121.0 ± 2 |
| temperature | | | | | |
| (° C.) | | | | | |
| Evaluation | Passed | Passed | Passed | Passed | Passed |
| of DC aging | | | | | |
| Evaluation | Passed | Passed | Passed | Passed | Passed |
| of heat cycle | | | | | |
| Drawability | ∘ | ∘ | ∘ | ∘ | ∘ |
| | Ex. 6 | Ex. 7 | Ex. 8 | Ex. 9 | Ex. 10 |
| In (w. %) | 65 | 65 | 70 | 70 | 80 |
| Sn (w. %) | 35 | 35 | 30 | 30 | 20 |
| Cu (w. %) | 0.4 | 4 | 0.4 | 4 | 0.4 |
| Operating | 126.0 ± 1 | 128.0 ± 2 | 128.0 ± 1 | 130.0 ± 3 | 134.0 ± 1 |
| temperature | | | | | |
| (° C.) | | | | | |
| Evaluation | Passed | Passed | Passed | Passed | Passed |
| of DC aging | | | | | |
| Evaluation | Passed | Passed | Passed | Passed | Passed |
| of heat cycle | | | | | |
| Drawability | ∘ | ∘ | ∘ | ∘ | ∘ |

| | Ex. 11 | Comp. Ex. 1 | Comp. Ex. 2 |
|---|---|---|---|
| In (w. %) | 80 | 74 | 52 |
| Sn (w. %) | 20 | 26 | 48 |
| Cu (w. %) | 4 | 0 | 0 |
| Operating | 136.0 ± 2 | 129.2 ± 1 | 119.0 ± 1 |
| temperature | | | |
| (° C.) | | | |
| Evaluation of | Passed | Not passed | Not passed |
| DC aging | | | |
| Evaluation of | Passed | Not passed | Not passed |
| heat cycle | | | |
| Drawability | ∘ | x | ∘ |

1. A wire member for a thermal fuse element which is a wire member for a fuse element of an alloy type thermal fuse, wherein a metal element for preventing long-term DC breakage is added to an In—Sn composition of 52 to 85% In and a balance Sn, said metal element preventing said fuse element from being broken under long-term DC application.

2. A wire member for a thermal fuse element according to claim 1, wherein said metal element for preventing long-term DC breakage is Cu, and an addition amount of said metal is 0.1 to 7.0 weight parts with respect to 100 weight parts of said In—Sn composition.

3. An alloy type thermal fuse wherein a wire member for a thermal fuse element according to claim 1 is used as a fuse element.

4. An alloy type thermal fuse wherein a wire member for a thermal fuse element according to claim 2 is used as a fuse element.

5. An alloy type thermal fuse according to claim 3, wherein a heating element for fusing off said fuse element is additionally disposed.

6. An alloy type thermal fuse according to claim 4, wherein a heating element for fusing off said fuse element is additionally disposed.
